(19) United States
(12) Patent Application Publication
(10) Pub. No.: US 2004/0026136 A1
(43) Pub. Date: Feb. 12, 2004

(54) Flip-touch handheld device

(75) Inventors: David Wayne Hill, Cary, NC (US); John Peter Karidis, Ossining, NY (US); Brian Hargrove Leonard, Durham, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/115,477

(22) Filed: Apr. 3, 2002

(51) Int. Cl. G06K 11/06

(52) U.S. Cl. 178/18.01

(57) ABSTRACT

The functions of a palmtop personal computer (PC) with a standard format keyboard (keyboard) are integrated with a personal digital assistant (PDA) having a touch-screen display with PDA control buttons to form a combination computing device. The PDA section is hingedly coupled over the keyboard of the palmtop PC section allowing the PDA display to have two positions. In the PDA position, the PDA section is placed over and latched onto the palmtop PC section. A display position sensor generates a signal indicating that the display is in the PDA display position. The display circuitry formats the display data for a portrait display mode for the PDA mode. If the PDA section is positioned for the palmtop PC mode exposing the keyboard, the display position sensor signals the display circuitry to format the display data for a landscape display mode. A user input may override the display format in the PDA mode.

### TECHNICAL FIELD

The present invention relates in general to handheld personal digital assistants (PDA) and palmtop personal computers (PC), and in particular to units that combine the functions of a PDA and a palmtop PC.

### BACKGROUND INFORMATION

With the increased usage of wireless technology, devices are being manufactured that have multiple functions. Telephones have displays as well as the normal alphanumerical key pad and are being designed to allow a user to access the Internet as well as provide other functions. PDAs, initially designed to provide calendar functions, address books, etc., are being designed with additional functions of telephony, audio, video, as well as computing functions. Sometimes these devices run application programs better suited to a landscape mode (longest display dimension is horizontal) of display rather than the normal portrait mode. A PDA, which is designed to minimize size, must use touch-screen display techniques, scrolling keys and other compact methods of accessing information within the device. Since the power of portable computer processors are on the rise, these devices may easily contain advanced computing capabilities. However, size constraints may not allow PDA devices to incorporate a usable manual keyboard which normally has a rectangular form factor. A typical PDA for calendar, telephony and address functions may be better suited for a display that has the longest display dimension in a user vertical orientation. On the other hand, a PDA or palm PC with video or computing functions may have applications that work best with a standard format keyboard and a display which has the longest display dimension in the user horizontal orientation.

There is, therefore, a need for a PDA-like device with its standard touch-screen display functionality and display orientation in conjunction with features that allow a standard format keyboard with corresponding horizontal display orientation of a palm PC without increasing the size of the physical PDA device.

### SUMMARY OF THE INVENTION

A combination computing (COM) device incorporates the functionality of a Personal Digital Assistant (PDA) device along with a touch-screen display, standard format keyboard and the functionality of a palmtop personal computer (PC). Display circuitry, within the COM device, automatically switches between a display format best suited for a palmtop PC with the standard format keyboard and a display format best suited for the functions of a PDA device. The COM device has two elements, the palmtop PC section and a PDA section. The PDA section is attached with hinges and fits over the palmtop PC section. Electronics for the combined functionality of the PDA and palm PC may be distributed and reside in either or both sections. The PDA touch-screen display is rectangular and substantially the same size as is consistent with the particular standard format keyboard section of the palmtop PC section. When the touch-screen display is positioned and latched over and hiding the standard format keyboard of the palmtop PC section, a display position sensor generates a signal that gates the display circuitry to format generated display data to correspond to the portrait mode of a PDA. When the touch-screen display is “opened”, it hinges away from the palmtop PC section and is positioned at a viewing angle relative to the user and corresponding to a landscape mode display. In this position (keyboard accessible) the display position sensor generates a signal that gates the display circuitry to format the display data to the corresponding landscape mode. Override circuits allows a user to put the COM device in either display mode when the display position sensor indicates the COM device is in the PDA operation mode. Additional circuitry is incorporated for switching selected PDA electronic devices to low power when in the palmtop PC operation mode and selected palmtop PC electronic devices to low power when in the PDA operation mode.

The PDA section has “hot” buttons which are used to activate PDA programs (e.g., calendar program) by pushing one selected button. The PDA section also has an up/down scroll button that is normally used to move vertically on the display when in the portrait display mode. A normal palmtop PC would also incorporate into the standard format keyboard hot buttons that are used to activate similar programs as those found on a stand alone PDA unit. In the COM unit of the present invention, the PDA hot buttons are used to activate programs in both the PDA and palmtop PC operation modes. Program hot buttons, normally required on a palmtop PC, are eliminated on the COM device of the present invention allowing more space to make the COM device standard format keys larger than those found on a typical stand alone palmtop PC. The COM device of the present invention also changes the function of the up/down scroll buttons of the PDA section when it is in the palmtop PC operation mode. In the COM device, the up/down PDA scroll buttons are converted to left/right scroll buttons when in the palmtop PC operation mode. The COM device requires only up/down scroll buttons on the standard format keyboard of the palmtop PC section for the vertical scroll in the palmtop PC operation mode. This allows two additional keys to be eliminated from the palmtop PC keyboard thus enabling larger keyboard keys and better keyboard functionality for the COM unit of the present invention. When the COM device is in the palmtop PC operation mode the PDA section vertical scroll buttons are naturally oriented for use as horizontal scroll buttons for the palmtop PC operation mode.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a PDA section with a touch-screen display and PDA control buttons according to embodiments of the present invention;

FIG. 2 illustrates a combination computing (COM) device showing the touch-screen display in for the palmtop PC operation mode;

FIG. 3 is a side view of the COM device illustrating a display position sensor and hinges for pivoting the touch-screen display;

FIG. 4 is a side view of a COM unit according to embodiments of the present invention;

FIG. 5 is a flow diagram of method steps used in embodiments of the present invention;

FIG. 6 is a view of the COM device illustrating the multi-hinged cover folded under the palmtop PC section;

FIG. 7 is a view of the COM device illustrating the multi-hinged cover partially open showing particular hinge areas of the multi-hinged cover; and

FIG. 8 is another view of the COM device illustrating the multi-hinged cover closed over the touch-screen display.

### DETAILED DESCRIPTION

In the following description, numerous specific details are set forth to provide a thorough understanding of the present invention. However, it will be obvious to those skilled in the art that the present invention may be practiced without such specific details. In other instances, well-known circuits may be shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views. In the following, the term “standard format keyboard” is used to describe a typewriter style keyboard that is normally incorporated within a palmtop personal computer (PC). The standard format keyboard has alphanumeric keys like a typewriter (e.g., Qwerty style); however, it would be reduced to a size and form factor dictated by the size of the touch-screen display normally found on a Personal Digital Assistant (PDA). The single term “keyboard” may be used interchangeably with the above described “standard format keyboard” to simplify the explanations. Also, PDA operation mode and palmtop PC operation mode are shortened to PDA mode and palmtop PC mode, respectively.

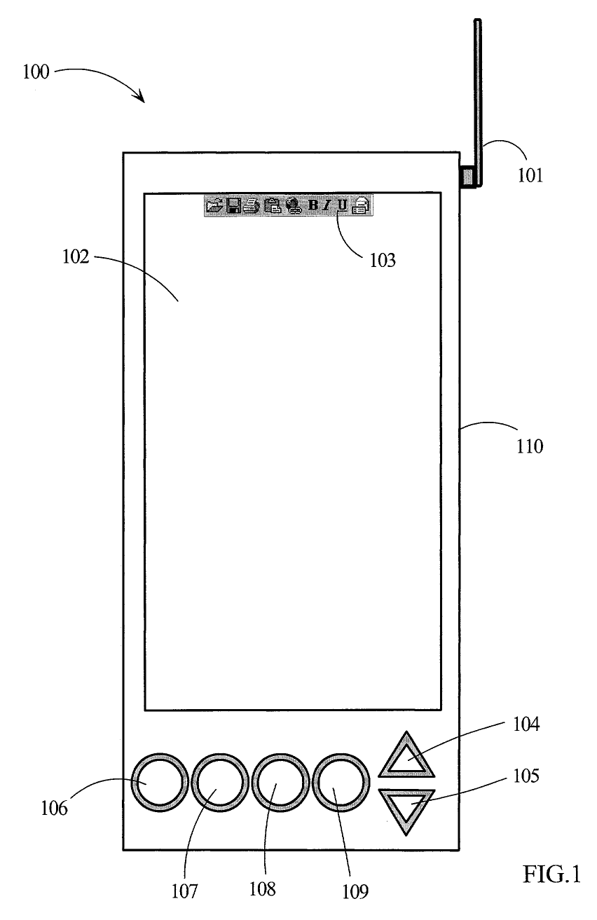

FIG. 1 is a view of the PDA section 110 of the combination computing (COM) device 100 according to embodiments of the present invention. The touch-screen display 102 is a rectangular size consistent with a PDA or palmtop PC. The PDA section 110 has control buttons 104-109 for navigating the touch-screen display and activating programs. Scroll buttons 104-105 are used to scroll vertically on touch-screen display 102 when in the PDA mode. A stylus (not shown) may be used to activate functions on touch-screen display 102. Exemplary tool bar 103 illustrates a view on touch-screen display 102 that may be present when COM device 100 is used in the PDA mode. Wireless antennae 101 is used to communicate with compatible external devices, for example, to access the Internet or to use telephony functions.

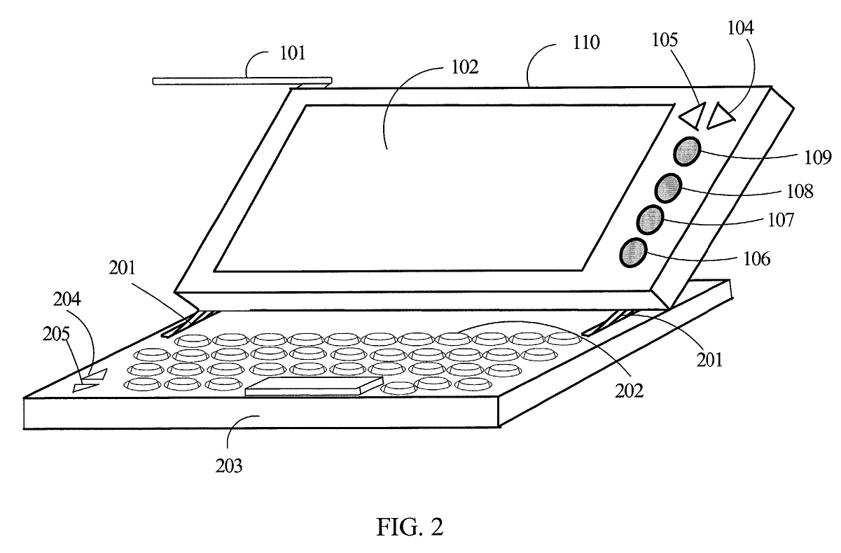

FIG. 2 illustrates the COM device 100 with the PDA section 110 pivoted so that the touch-screen display 102 is in viewing position best suited for using a standard format keyboard (keyboard) 202. Hinges 201 are designed to allow PDA section 110 to move from a position over the keyboard 202, when in the PDA mode, to an inclined position away from keyboard 202 when in the palmtop PC mode. Touch-screen display 102 is a size as consistent with keyboard 202. PDA control buttons 106-109 are used as “hot” buttons for common program functions used in the PDA mode and the palmtop PC mode. Vertical scroll buttons 104-105 on the PDA section 110 automatically change to horizontal scroll buttons when in the palmtop PC mode. This enables the horizontal scroll buttons normally on the keyboard 202 to be eliminated. However, provisions are made to allow a user to override the portrait display mode and enable the landscape display mode when the COM device 100 is operated in the PDA mode. In the PDA mode, with keyboard 202 hidden, it is easy for a user to rotate the COM device 100 for either a portrait or landscape display viewing.

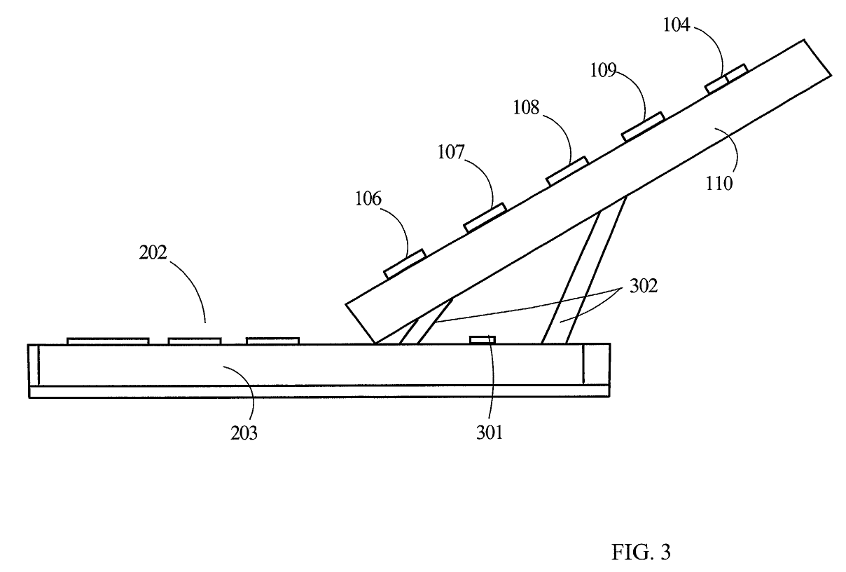

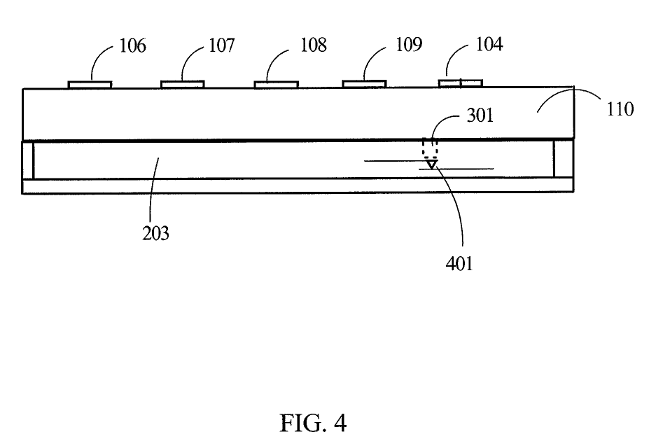

FIG. 3 is a side view of the COM device 100 of FIG. 1 and FIG. 2 showing PDA section 110 with control buttons 104-109. Hinge and pivots 301 are used to hold PDA section 110 at a desired viewing angle relative to keyboard 102. A switch button 301 activates a switch (not shown) in palm PC section 203 and is used as the display position sensor. When the touch-screen display 102 is pivoted for the palm PC mode, the contacts of switch 401 (see FIG. 4) may be open, generating one state of a display position sensor signal. When touch-screen display 102 is pivoted closed (in the PDA mode), the contacts of switch 401 close generating the second state of the display position signal.

FIG. 4 shows the side view of COM device 100 when the PDA section 110 is closed and covering keyboard 202 and palmtop PC section 203. Button 301 is depressed into palm PC section 203 and closes the contacts of a switch 401. PDA control buttons 104-109 are also visible.

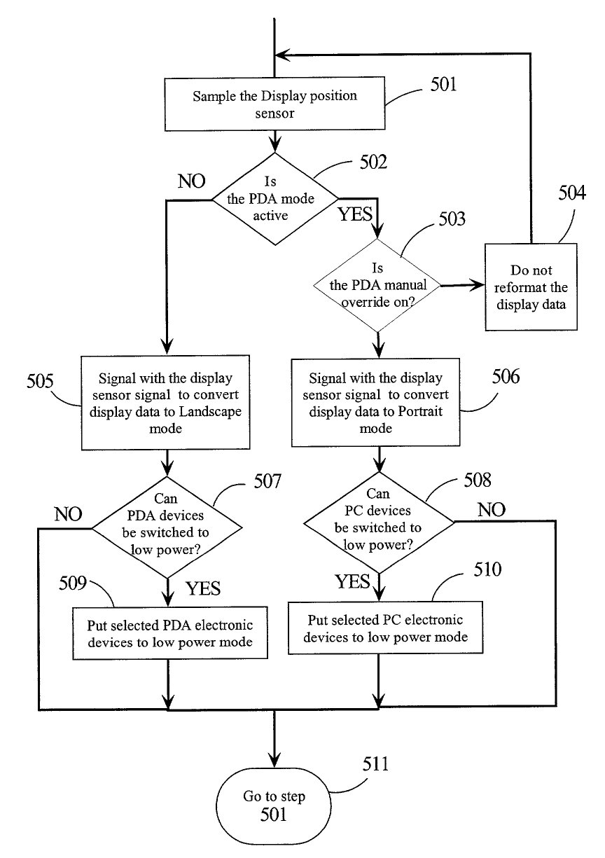

FIG. 5 is a flow diagram of method steps used for COM device 100 according to embodiments of the present invention. In step 501, the display position signal generated by display position sensor (switch 401) is sampled to determine the position of touch-screen display 102. In step 502, a test is done to determine if the PDA mode is active. If the result of the test in step 502 is YES, then a test is done in step 503 to determine if the manual override of the normal portrait display mode for PDA operation is active. If the result of the test in step 503 is YES, then in step 504 the display data (for touch-screen display 102) is not reformatted and a return is taken back to step 501. If the result of the test in step 503 is NO, then in step 508 the state of the display position signal triggers circuits in COM device 100 to convert the display data to the portrait display mode. In step 509, a test is done to determine if selected palmtop PC electronic devices, not being used in the PDA mode, may be switched to low power. If the result of the test in step 509 is YES, than in step 510 the selected palm PC devices are put in low power. In step 511, a branch is taken back to step 501 to continue sampling the display position signal.

If the result of the test in step 502 is NO, then in step 505 display circuits in the COM device 100 are signaled to format the display data for the landscape display mode. In step 507, a test is done to determine if unused PDA electronic devices may be switched to low power. If the result of the test in step 507 is YES, then in step 509 selected PDA devices are put in low power and in step 511 a branch is taken back to step 501. If the result of the test in step 507 is NO, then step 511 is executed as above.

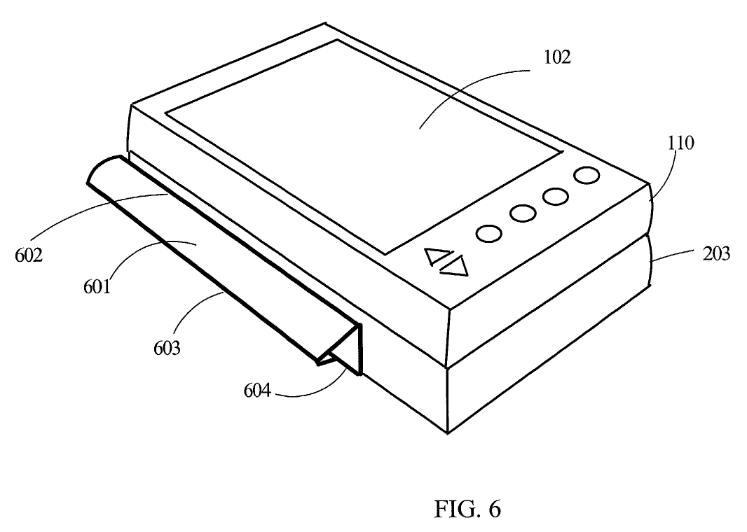

FIG. 6 is a view of COM device 100 with a multi-hinged cover 601 shown folded under the palm PC section 203. The multiple hinge lines 602, 603 and 604 are also shown in this view. The multiple hinges 602-603 allow cover 601 to be folded out of the way of the user. PDA section 110 and touch-screen display 102 are also shown in relation to multi-hinged cover 601. Hinges 602-603 are shown in their relative positions as cover 601 closes over touch-screen display 102. PDA section 110 is shown positioned slightly above palmtop PC section 203 as the touch-screen display 102 is being moved for the palmtop PC mode. Multi-hinged cover 601 protects touch-screen display 102 when it is closed. When cover 601 is open, it may be folded under palmtop PC section 203 allowing either the PDA mode or the palmtop PC mode.

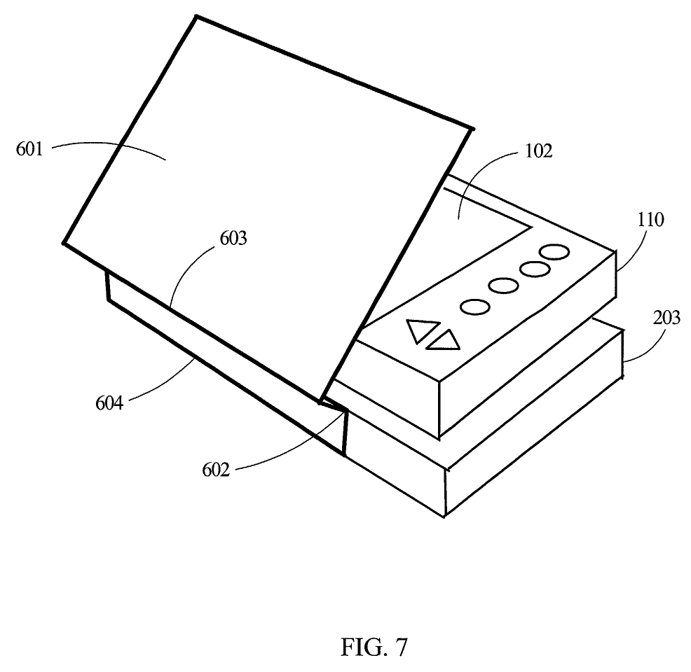

FIG. 7 is another view of COM device 100 illustrating the multi-hinged cover 601. Hinges 602-603 are shown in their positions as cover 601 closes over touch-screen display 102. PDA section 110 is shown slightly above palmtop PC section 203 as touch-screen display 102 is being positioned.

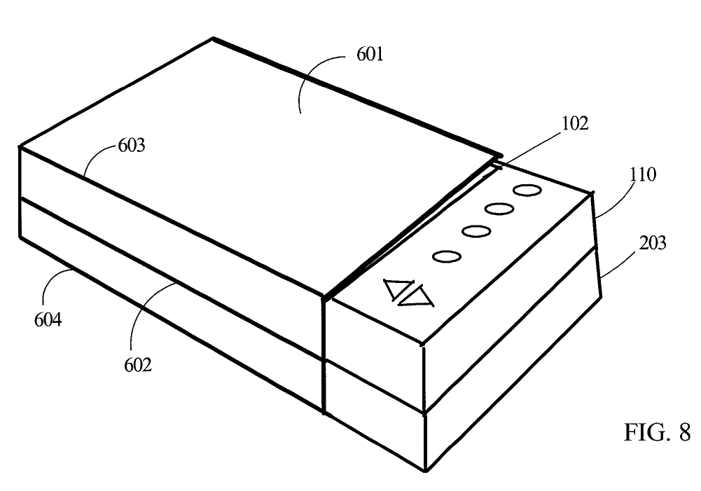

FIG. 8 is a view of COM device 100 with the multi-hinged cover 601 nearly closed over touch-screen display 102. In this position, hinges 602-603 form break lines for cover 601 as it conforms to the shape of COM device 100.

Although the present invention and its advantages have been described in detail, it should be understood that various changes, substitutions and alterations can be made herein without departing from the spirit and scope of the invention as defined by the appended claims.

What is claimed is:

1. A combination computing device comprising:
a palmtop personal computer (PC) section with an integrated standard format keyboard (“keyboard”);
a Personal Digital Assistant (PDA) section having a touch-screen display with PDA control buttons, said PDA section hingedly coupled to said palmtop PC section and having a first functional position when positioned over said keyboard and a second functional position when positioned exposing said keyboard for a user access;
a display position sensor for generating a display position signal with a first signal state when said PDA section is positioned in said first functional position and a second signal state when said PDA section is positioned in said second functional position; and
display circuitry for formatting display data for said touch-screen display for a portrait display mode in response to said first signal state and a landscape display mode in response to said second signal state.

2. The combination computing device of claim 1 further comprising central processing circuitry electrically coupled to said palmtop PC section and said PDA section, said central processing circuitry set to a PDA operation mode in response to said first signal state and a palmtop PC operation mode in response to a said second signal state.

3. The combination computing device of claim 2, wherein said display data formatted to said portrait display mode is switched to said landscape display mode by a user input when said display position signal has said first signal state.

4. The combination computing device of claim 1, wherein data received from PDA vertical display scroll buttons function as palmtop PC horizontal display scroll buttons when in said palmtop PC operation mode.

5. The combination computing device of claim 1 further comprising:
an antennae coupled to transceiver circuitry, said transceiver circuitry receiving and transmitting data signals for said central processing circuitry.

6. The combination computing device of claim 1, wherein said central processing circuitry receives inputs from said touch-screen display and said PDA control buttons and generates display data for said touch-screen display when in said PDA operation mode.

7. The combination computing device of claim 1, wherein said central processing circuitry receives inputs from said keyboard and said PDA control buttons and generates display data for said touch-screen display when in said palmtop PC operation mode.

8. The combination computing device of claim 1, wherein selected electronic devices used for said PDA operation mode are switched to low power when in said palmtop PC operation mode and selected electronic devices used for said palmtop PC operation mode are switched to low power when in said PDA operation mode.

9. The combination computing device of claim 1, wherein said PDA section is positioned and latched over said keyboard in said first functional position.

10. The combination computing device of claim 1, wherein said PDA section and said touch-screen display are positioned at an angle relative to said keyboard in said second functional position.

11. A method for a combination computing device comprising the steps of:
hingedly coupling a palmtop personal computer (PC) unit with an integrated standard format keyboard (“keyboard”) to a Personal Digital Assistant (PDA) unit having a touch-screen display with PDA control buttons, said PDA unit having a first functional position when positioned over said standard format keyboard and a second functional position when positioned exposing said keyboard for a user access;
generating a display position signal with a first signal state when said PDA unit is positioned in said first functional position and a second signal state when said PDA unit is positioned in said second functional position; and
formatting display data for said touch-screen display for a portrait display mode in response to said first signal state and a landscape display mode in response to said second signal state.

12. The method of claim 11 further comprising the step of:
setting central processing circuitry electrically coupled to said palmtop PC unit and said PDA unit to a PDA operation mode in response to said first signal state and a palmtop PC operation mode in response to a said second signal state.

13. The method of claim 11 further comprising the step of:
switching said display data formatted to said portrait display mode to said landscape display mode by a user input when said display position signal has said first signal state.

14. The method of claim 12 further comprising the step of:
using data from PDA vertical display scroll buttons as palmtop PC horizontal display scroll data when in said palmtop PC operation mode.

15. The method of claim 14 further comprising the steps of:
coupling antennae and transceiver circuitry to said central processing circuitry and;
receiving and transmitting data signals for said central processing circuitry.

16. The method of claim 12, wherein said central processing circuitry receives inputs from said touch-screen display and said PDA control buttons and generates display data for said touch-screen display when in said PDA operation mode.

17. The method of claim 12, wherein said central processing circuitry receives inputs from said keyboard and said PDA control buttons and generates display data for said touch-screen display when in said palmtop PC operation mode.

18. The method of claim 12, wherein selected electronic devices used for said PDA operation mode are switched to low power when in said palmtop PC operation mode and selected electronic devices used for said palmtop PC operation mode are switched to low power when in said PDA operation mode.

19. The method of claim 11, wherein said PDA unit is positioned and latched over said keyboard in said first functional position.

20. A combination computing device comprising:
a palmtop personal computer (PC) section with an integrated standard format keyboard (keyboard);
a Personal Digital Assistant (PDA) section having a touch-screen display with PDA control buttons, said PDA section hingedly coupled to said palmtop PC section and having a first functional position when positioned over said keyboard and a second functional position when positioned exposing said keyboard for a user access;
a display position sensor for generating a display position signal with a first signal state when said PDA section is positioned in said first functional position and a second signal state when said PDA section is positioned in said second functional position;
display circuitry for formatting display data for said touch-screen display for a portrait display mode in response to said first signal state and a landscape display mode in response to said second signal state; and
a multiple hinged cover coupled to said palmtop PC unit, said multiple hinged cover folding over said PDA touch-screen display in a first cover position and folding under said palmtop PC section in a second cover position.

21. The combination computing device of claim 20 further comprising central processing circuitry electrically coupled to said PPC section and said PDA section, said central processing circuitry set to a PDA operation mode in response to said first signal state and a PPC operation mode in response to a said second signal state.

22. The combination computing device of claim 20, wherein said display data formatted to said portrait display mode is switched to said landscape display mode by a user input when said display position signal has said first signal state.

23. The combination computing device of claim 21, wherein data received from PDA control buttons function as palmtop PC control buttons when in said palmtop PC operation mode.

24. The combination computing device of claim 20 further comprising:
an antennae coupled to transceiver circuitry, said transceiver circuitry receiving and transmitting data signals for said central processing circuitry.

25. A computing device comprising:
a personal digital assistant (PDA) touch-screen display with PDA control buttons hingedly coupled over a palmtop personal computer (PC); and
display circuitry receiving a position control signal and automatically formatting data for said PDA touch-screen display for a first display mode when said PDA touch-screen display is positioned over and covering a standard format keyboard (keyboard) of said palmtop PC and formatting data for said PDA touch-screen display for a second display mode when said PDA touch-screen display is positioned exposing said keyboard of said palmtop PC for user access.

26. The computing device of claim 25, wherein said position control signal has a first signal state when said PDA touch-screen display is positioned for said first display mode and a second signal state when said PDA touch-screen display is positioned for said second display mode.

27. The computing device of claim 25, wherein said first display mode is a portrait display mode.

28. The computing device of claim 25, wherein said second display mode is a landscape display mode.

29. The computing device of claim 25 further comprising a multiple hinged cover coupled to said computing device, said multiple hinged cover folding over said PDA touch-screen display in a first cover position and folding under said palmtop PC in a second cover position.

30. A method for operating a computing device having a personal digital assistant (PDA) unit with a touch-screen display with PDA control buttons and a palmtop personal computer (PC) unit with a standard format keyboard (keyboard) comprising the steps of:
coupling said PDA unit hingedly over said keyboard of said palmtop PC unit;
generating a position signal with a display position sensor, said position signal having a first signal state when said PDA unit is positioned over said keyboard blocking its use and having a second signal state when said PDA unit is positioned exposing said keyboard for user access; and
receiving said position signal and formatting display data for said PDA touch-screen display for a first display mode in response to said first signal state of said position signal and formatting display data for said PDA touch-screen display for a second display mode in response to said second signal state of said position signal.

31. The method of claim 30 further comprising the step of:
using said PDA control buttons as palmtop PC control buttons when in said second display mode.

32. The method of claim 30, wherein said first display mode is a portrait display mode and said second display mode is a landscape display mode.
